(19) United States
(12) Patent Application Publication
(10) Pub. No.: US 2016/0239144 A1
(43) Pub. Date: Aug. 18, 2016

(54) TOUCHSCREEN DEVICE AND ITS TOUCH TRAJECTORY SENSING METHOD

(71) Applicant: eGalax_eMPIA Technology Inc., Taipei City (TW)

(72) Inventor: Chi-Hao TANG, Taipei City (TW)

(21) Appl. No.: 14/825,578

(22) Filed: Aug. 13, 2015

(30) Foreign Application Priority Data
Feb. 17, 2015 (TW) 104105595

(51) Int. Cl. G06F 3/041

(52) U.S. Cl. CPC G06F 3/0416; G06F 2203/04112

(57) ABSTRACT

A touchscreen device using a touch trajectory sensing method that determines the moving trajectory of each object being moved into contact with the touch sensing panel and the trajectory sensing area around each touch point according to the movement speed of the respective touch point, where the trajectory sensing area exhibits a positive correlation with the movement speed so that when multiple objects simultaneously contact with the touch sensing panel and then stayed at the respective touch points, or steered on the touch sensing panel, each touch point has a relatively smaller trajectory sensing area at the turning point or retarded point on the touch sensing panel, preventing adjacent touch points at different moving trajectories from falling to the respective opponent second trajectory sensing areas to further eliminate the control unit from making a wrong moving trajectory determination and the touch sensing panel from performing an unexpected touch control operation.

This application claims the priority benefit of Taiwan patent application number 104105595, filed on Feb. 17, 2015.

### BACKGROUND OF THE INVENTION

1. Field of the Invention

The present invention relates to touch control technology and more particularly, to a touchscreen device and its touch trajectory sensing method, wherein when multiple objects are moved into contact with the touch sensing panel of the touchscreen device and stayed at the respective touch points or moved, the touch trajectory sensing method determines the moving trajectory of each object on the touch sensing panel of the touchscreen device and the trajectory sensing area around each touch point according to the movement speed of the respective touch point, preventing from making a wrong moving trajectory determination and eliminating the touch sensing panel from performing an unexpected touch control operation.

2. Description of the Related Art

In order to mate with human intuition, touchscreen device has been widely used in a variety of modern electronic devices, allowing the user to operate the electronic device by touching the touch sensing panel of the touchscreen device of the electronic device using one finger or a conductive stylus.

FIGS. 13-15 illustrate different application examples of a touch trajectory sensing method according to the prior art. As illustrated, when an object (such as finger or conductive stylus) is moved on a touch sensing panel of a touchscreen device to create a moving trajectory K₁, a control unit of the touchscreen device acquires a first touch point M₁₁ from the touch sensing panel, and then defines a first trajectory sensing area A₁₁ around the first touch point M₁₁. When a next sensing time is up, the control unit detects a second touch point M₁₂ in the first trajectory sensing area A₁₁ within the touch sensing panel, and then defines a second trajectory sensing area A₁₂ around the second touch point M₁₂ for determining a moving trajectory from the second touch point M₁₂ to the third touch point M₁₃ using the second trajectory sensing area A₁₂.

When two objects are moved on the touch sensing panel to create two moving trajectories K₁,K₂, the control unit sequentially detects first touch points M₁₁,M₂₁, second touch points M₁₂,M₂₂ and third touch points M₁₃,M₂₃. However, when these two objects are moved from the respective second touch points M₁₂,M₂₂ to the respective third touch point M₁₃,M₂₃, the third touch point M₂₃ is disposed near the second touch point M₁₂ and falls within the second trajectory sensing area A₁₂ of the second touch point M₁₂, and the control unit can erroneously determine the second touch point M₁₂ and the third touch points M₁₃,M₂₃ to be of one same moving trajectory, causing the touch sensing panel to perform an unexpected touch control operation.

Therefore, how to prevent a control unit of a touchscreen device from making a wrong moving trajectory determination when multiple objects are forced into contact with a touch sensing panel of the touchscreen device and moved on the touch sensing panel to perform a special sliding action such as change of direction is the goal manufacturers engaged in this industry are anxious to achieve.

### SUMMARY OF THE INVENTION

The present invention has been accomplished under the circumstances in view. It is therefore the main object of the present invention to provide a touchscreen device and its touch trajectory sensing method, which defines a second trajectory sensing area using the movement speed of the touch point, preventing from making a wrong moving trajectory determination and eliminating the touch sensing panel from performing an unexpected touch control operation.

When multiple objects are moved into contact with the touch sensing panel of the touchscreen device and stayed at the respective touch points or moved, the touch trajectory sensing method determines the moving trajectory of each object on the touch sensing panel of the touchscreen device and the trajectory sensing area around each touch point according to the movement speed of the respective touch point, where the trajectory sensing area exhibits a positive correlation with the movement speed. Thus, when multiple objects are simultaneously moved into contact with the touch sensing panel and then stayed at the respective touch points, or steered on the touch sensing panel, each touch point has a relatively smaller trajectory sensing area at the turning point or retarded point on the touch sensing panel, preventing adjacent touch points at different moving trajectories from falling to the respective opponent second trajectory sensing areas to further eliminate the control unit from making a wrong moving trajectory determination on the adjacent touch points, and thus, the invention can provide the user with excellent touch operation experience.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic circuit diagram of a touchscreen device in accordance with the present invention.

FIG. 2 is an operation flow chart of a touch trajectory sensing method in accordance with the present invention.

FIG. 3 is a schematic drawing illustrating two fingers touched the touch sensing panel of the touchscreen device in accordance with the present invention.

FIG. 4 is a schematic drawing illustrating a first application example of the touch trajectory sensing method in accordance with the present invention (I).

FIG. 5 is a schematic drawing illustrating a first application example of the touch trajectory sensing method in accordance with the present invention (II).

FIG. 6 is a schematic drawing illustrating a first application example of the touch trajectory sensing method in accordance with the present invention (III).

FIG. 7 is a schematic drawing illustrating a second application example of the touch trajectory sensing method in accordance with the present invention (I).

FIG. 8 is a schematic drawing illustrating a second application example of the touch trajectory sensing method in accordance with the present invention (II).

FIG. 9 is a schematic drawing illustrating a second application example of the touch trajectory sensing method in accordance with the present invention (III).

FIG. 10 is a schematic drawing illustrating a third application example of the touch trajectory sensing method in accordance with the present invention (I).

FIG. 11 is a schematic drawing illustrating a third application example of the touch trajectory sensing method in accordance with the present invention (II).

FIG. 12 is a schematic drawing illustrating a third application example of the touch trajectory sensing method in accordance with the present invention (III).

FIG. 13 is a schematic drawing illustrating an application example of a touch trajectory sensing method according to the prior art (I).

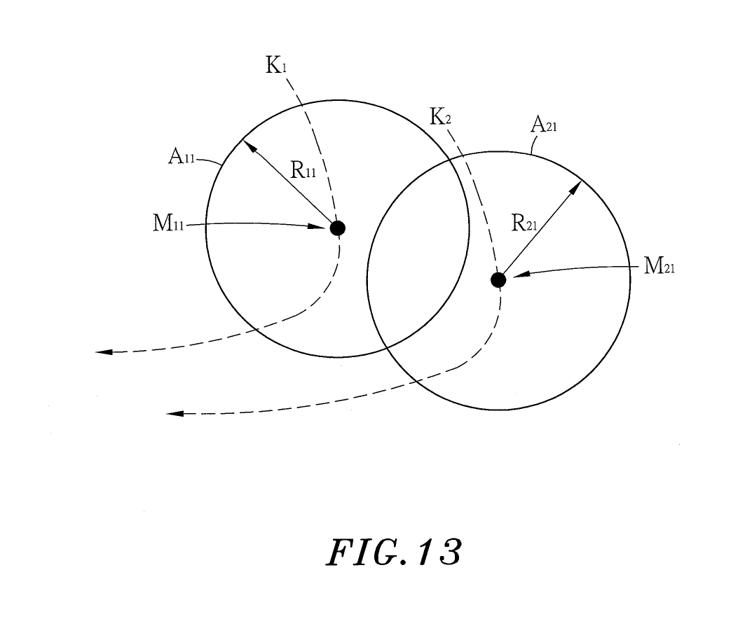

FIG. 14 is a schematic drawing illustrating an application example of a touch trajectory sensing method according to the prior art (II).

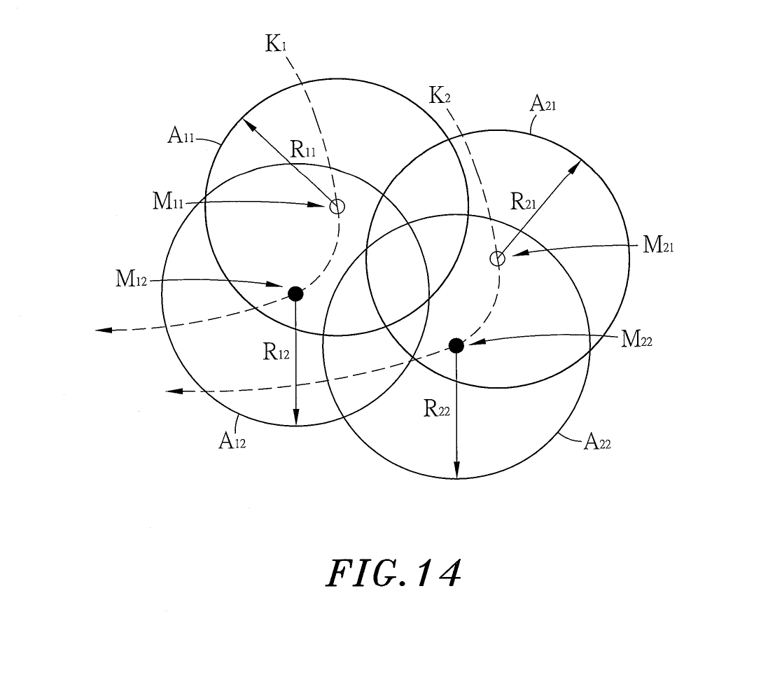

FIG. 15 is a schematic drawing illustrating an application example of a touch trajectory sensing method according to the prior art (III).

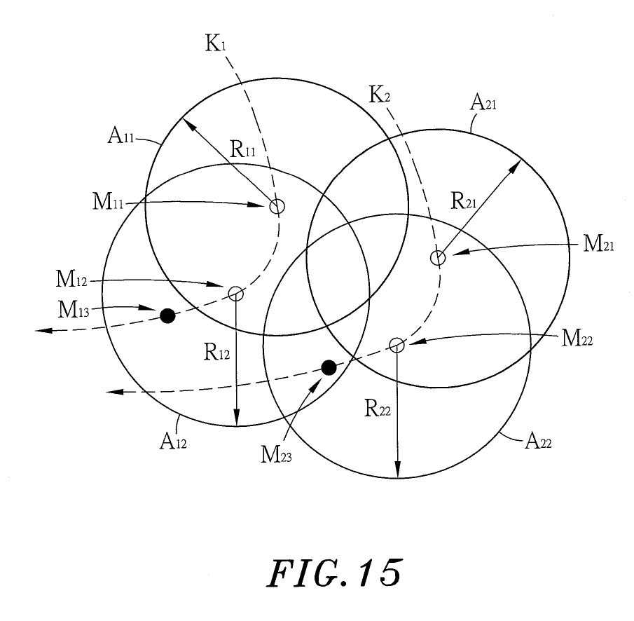

### DETAILED DESCRIPTION OF THE PREFERRED EMBODIMENT

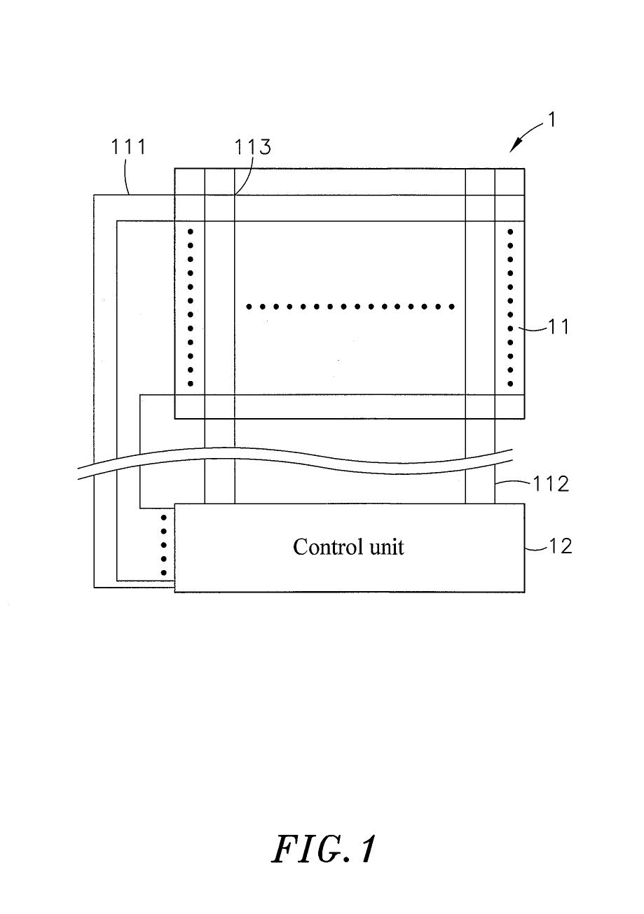

Referring to FIG. 1, a touchscreen device 1 in accordance with the present invention is shown. As illustrated, the touchscreen device 1 comprises a touch sensing panel 11 and a control unit 12. The touch sensing panel 11 comprises a plurality of driving lines 111 transversely arranged in parallel and electrically coupled to the control unit 12, a plurality of sensing lines 112 longitudinally arranged in parallel and electrically coupled to the control unit 12 and respectively intersected with the driving lines 111 to form a Cartesian coordinate system, and a sensing point 113 located at each intersection between each driving line 111 and each sensing line 112 corresponding to one respective coordinate in the Cartesian coordinate system.

In this embodiment, the driving lines 111 and the sensing lines 112 are intersected to form a Cartesian coordinate system. However, this example is not a limitation. In actual application of the touch trajectory sensing method, the driving lines 111 can be arranged in the touch sensing panel 11 in a radial manner to extend from the center of the touch sensing panel 11 radially toward the border edge thereof, and the sensing lines 112 can be concentrically arranged in the touch sensing panel 11 and intersected with the radially extending driving line 111 to form a polar coordinate system so that a sensing point 13 is formed at each intersection between each driving line 111 and each sensing line 112 corresponding to one respective coordinate in the polar coordinate system.

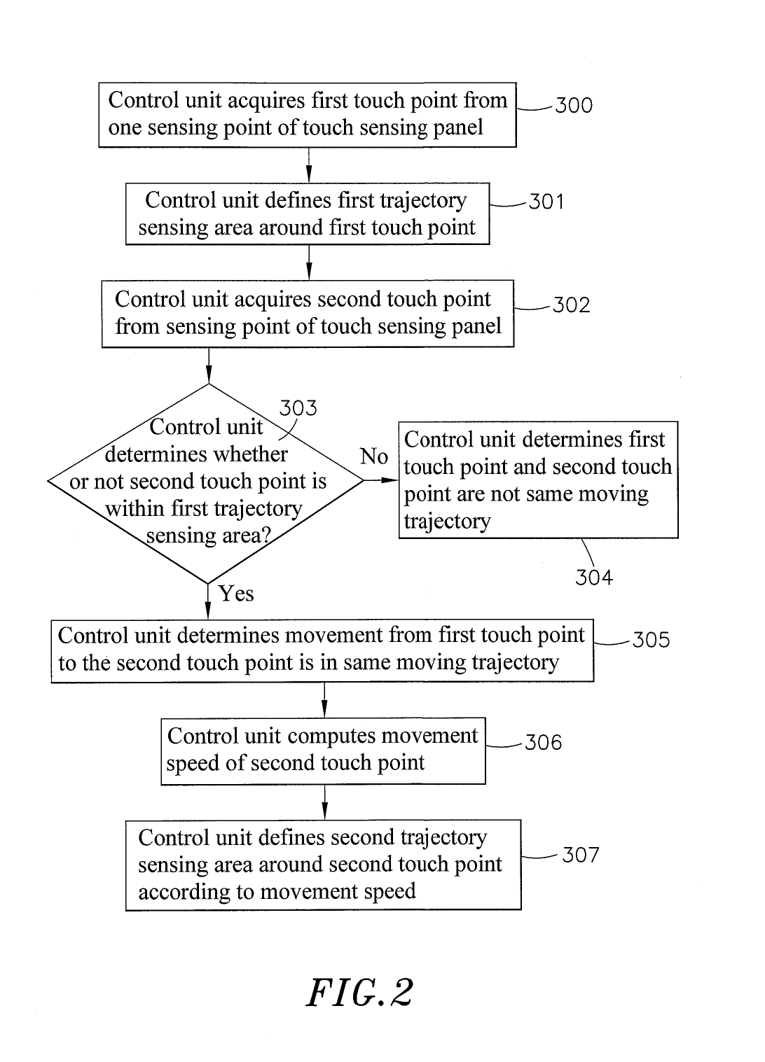

Referring to FIG. 2, the implementation of the touch trajectory sensing method in the touchscreen device comprises the steps of:

(300) Control unit 12 acquires a first touch point M₁₁ from one sensing point 113 of the touch sensing panel 11.

(301) Control unit 12 defines a first trajectory sensing area A₁₁ around the first touch point M₁₁.

(302) Control unit 12 acquires a second touch point M₁₂ from a sensing point 113 of the touch sensing panel 11.

(303) Control unit 12 determines whether the second touch point M₁₂ is within the first trajectory sensing area A₁₁ or not, and then proceeds to step (304) if negative, or step (305) if positive.

(304) Control unit 12 determines the first touch point M₁₁ and the second touch point M₁₂ are not the same moving trajectory.

(305) Control unit 12 determines the movement from the first touch point M₁₁ to the second touch point M₁₂ is in the same moving trajectory K₁.

(306) Control unit 12 computes the movement speed V₁₂ of the second touch point M₁₂.

(307) Control unit 12 defines a second trajectory sensing area A₁₂ around the second touch point M₁₂ according to the movement speed V₁₂.

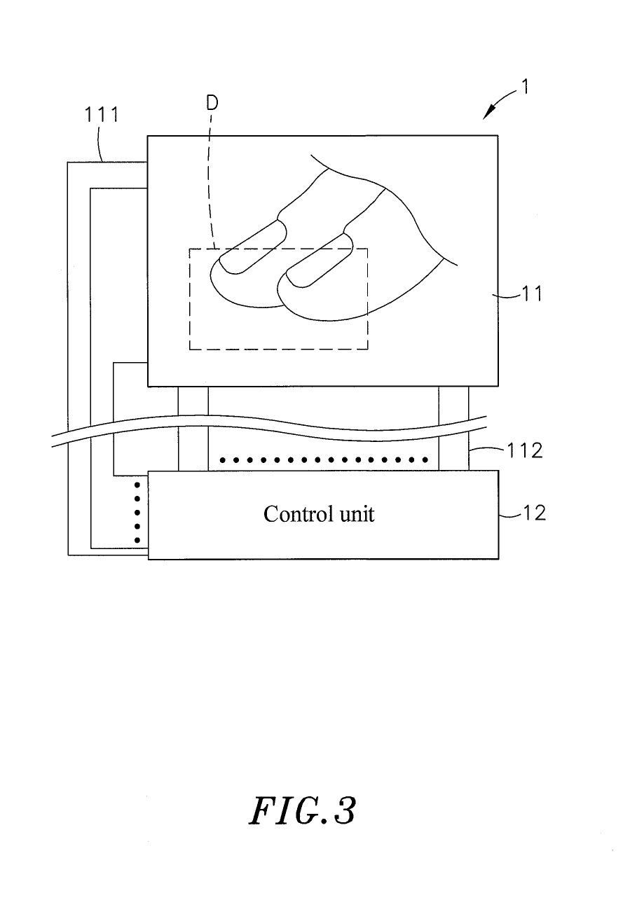

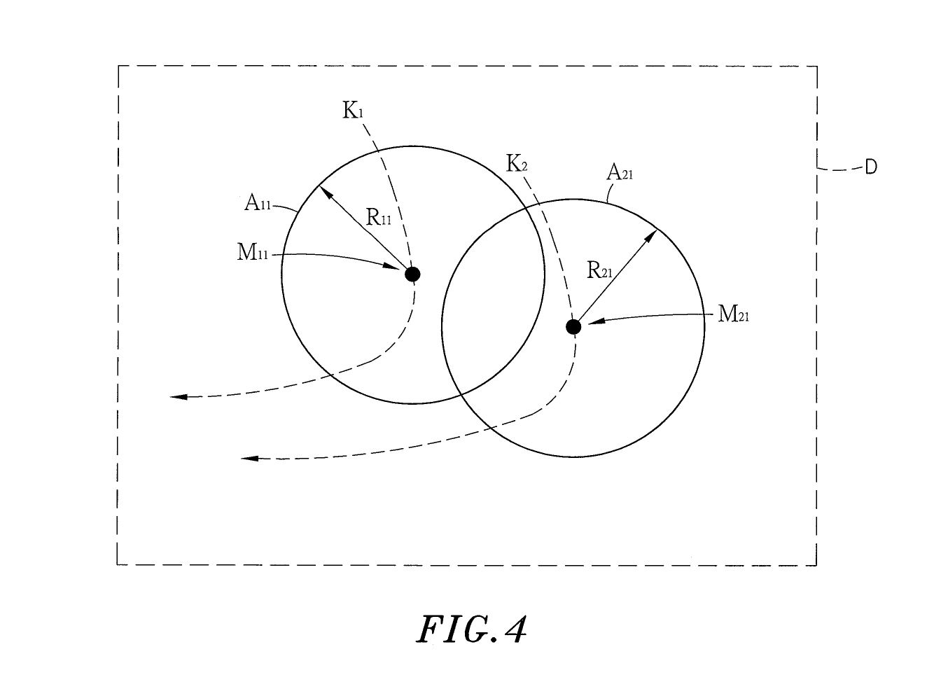

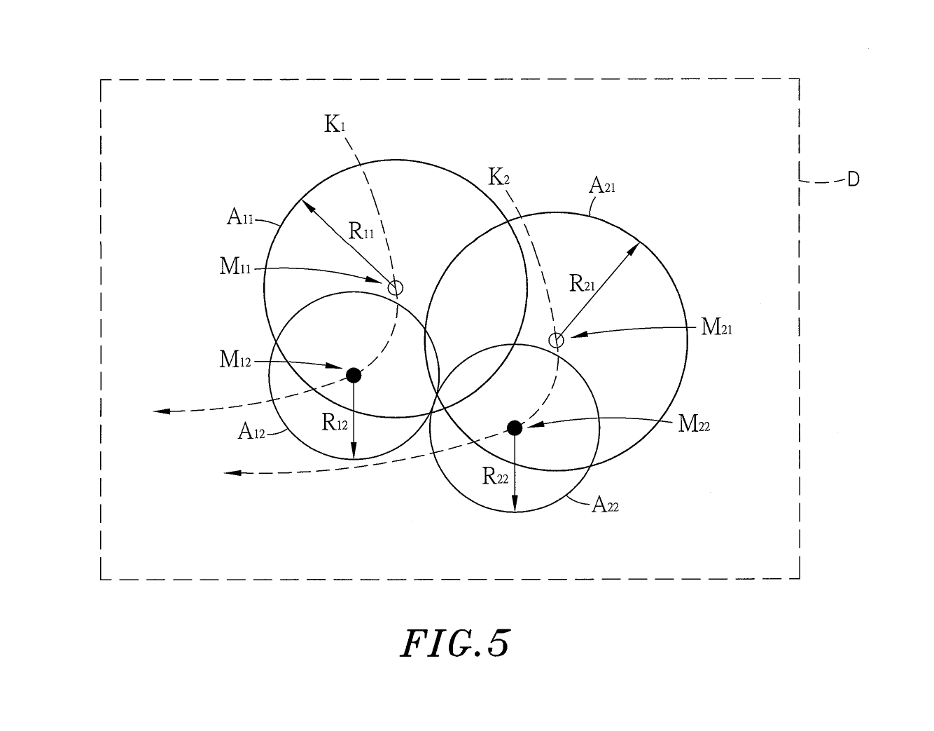

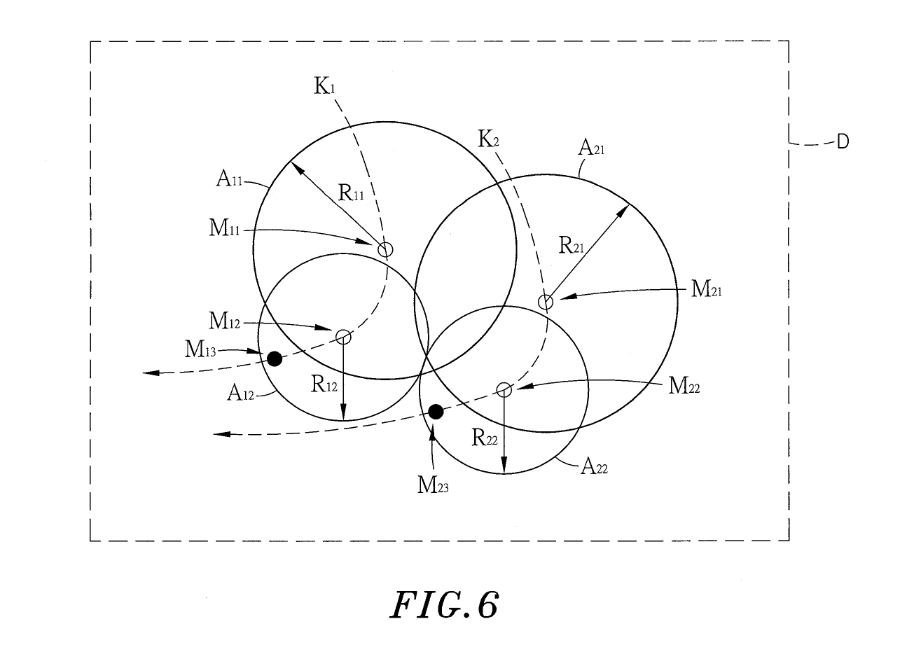

Referring to FIGS. 3-6, when two parallel objects (such as two fingers) simultaneously touch the touch sensing panel 11 and move on the touch sensing panel 11 in one same direction to create respective moving trajectories K₁,K₂, the control unit 12 will be able to detect the location information of two first touch points M₁₁,M₂₁ from two sensing points 113 at the touch sensing panel 11. After detection of the location information, the control unit 12 will draw a respective perfect circle with the center at each first touch point M₁₁,M₂₁ using a first sensing radius R₁₁,R₂₁, and then define a respective first trajectory sensing area A₁₁,A₂₁ around the respective first touch point M₁₁,M₂₁.

If the first touch points M₁₁,M₂₁ are the respective initial touch points of the respective moving trajectories K₁,K₂, the control unit 12 defines the first sensing radius R₁₁,R₂₁ of the respective first trajectory sensing area A₁₁,A₂₁ according to a predetermined initial value; if the first touch points M₁₁,M₂₁ are not the respective initial touch points of the respective moving trajectories K₁,K₂, it means that each first touch point M₁₁,M₂₁ has a respective movement speed V₁₁,V₂₁, and thus, the control unit 12 defines the first sensing radius R₁₁,R₂₁ of the respective first trajectory sensing area A₁₁,A₂₁ according to the movement speed V₁₁,V₂₁, where the first sensing radius R₁₁,R₂₁ exhibits a positive correlation with the movement speed V₁₁,V₂₁ of the respective first touch point M₁₁,M₂₁.

Thereafter, the control unit 12 detects the location information of two second touch points M₁₂,M₂₂ from respective two sensing points 113 at the touch sensing panel 11, where these two second touch points M₁₂,M₂₂ are respectively located within the respective first trajectory sensing areas A₁₁,A₂₁, and therefore, the control unit 12 determines the first touch point M₁₁ and the second touch point M₁₂ are of one same moving trajectory K₁, the first touch point M₂₁ and the second touch point M₂₂ are of another same moving trajectory K₂.

Because the second touch point M₁₂ is not within the respective first trajectory sensing area A₂₁ and the second touch point M₂₂ is not within the respective first trajectory sensing area A₁₁, the control unit 12 determines that the first touch point M₁₁ and the second touch point M₂₂ are not in one same moving trajectory; the first touch point M₂₁ and the second touch point M₁₂ are not in one same moving trajectory.

After the control unit 12 determined that the first touch points M₁₁,M₂₁ and the second touch points M₁₂,M₂₂ are respectively located within the respective moving trajectories K₁,K₂, the control unit 12 immediately computes the movement speed V₁₂,V₁₂ of each second touch point M₁₂,M₂₂, and then defines a second sensing radius R₁₂,R₂₂ for each second touch point M₁₂,M₂₂ according to the respective movement speed V₁₂,V₁₂, and then draws a respective perfect circle with the center at each second touch point M₁₂,M₂₂ using the second sensing radius R₁₂,R₂₂ and then defines a respective second trajectory sensing area A₁₂,A₂₂ around the respective second touch point M₁₂,M₂₂ using the respective perfect circle thus obtained.

The length of each second sensing radius R₁₂,R₂₂ exhibits a positive correlation with the movement speed V₁₂,V₂₂, and therefore, the second trajectory sensing area A₁₂,A₂₂ around the respective second touch point M₁₂,M₂₂ exhibits a positive correlation with the movement speed V₁₂,V₂₂.When the moving direction of an object is changed, its movement speed is lowered, and therefore the second trajectory sensing area A₁₂,A₂₂ around the respective second touch point M₁₂,M₂₂ will be relatively reduced subject to reduction of the movement speed V₁₂,V₂₂, shortening the second sensing radius R₁₂,R₂₂.

Thereafter, the control unit 12 will detect the location information of third touch points M₁₃,M₂₃ adjacent to the respective second touch points M₁₂,M₂₂. Because these third touch points M₁₃,M₂₃ are respectively located within the respective second trajectory sensing areas A₁₂,A₂₂, the control unit 12 determines that the second touch point M₁₂ and the third touch point M₁₃ are in one same moving trajectory K₁; the second touch point M₂₂ and the third touch point M₂₃ are in another same moving trajectory K₂.

Because the second sensing radius R₁₂ of the second trajectory sensing area A₁₂ exhibits a positive correlation with the movement speed V₁₂, is relatively reduced second trajectory sensing area A₁₂ around the second touch point M₁₂ to provide a reduced second sensing radius R₁₂ subject to reduction of the movement speed V₁₂ at the turning point, and thus, the third touch point M₂₃ near the second touch point M₁₂ is not located within the second trajectory sensing area A₁₂, preventing the control unit 12 from determining the second touch point M₁₂ and the third touch point M₂₃ to be within one same moving trajectory to further cause the touch sensing panel 11 to perform an unexpected touch control operation, and thus, the invention can provide the user with excellent touch operation experience.

The second sensing radiuses R₁₂,R₂₂ of the aforesaid second trajectory sensing areas A₁₂,A₂₂ are smaller than a predetermined upper limit value, preventing certain touch points near the second touch points M₁₂,M₂₂ from falling to the respective opponent second trajectory sensing areas A₁₂,A₂₂ due to an excessive high movement speed V₁₂,V₂₂ of the two objects so as to further eliminate the control unit 12 from making a wrong moving trajectory determination on the second touch points M₁₂,M₂₂ and the follow-up third touch points M₁₃,M₂₃.

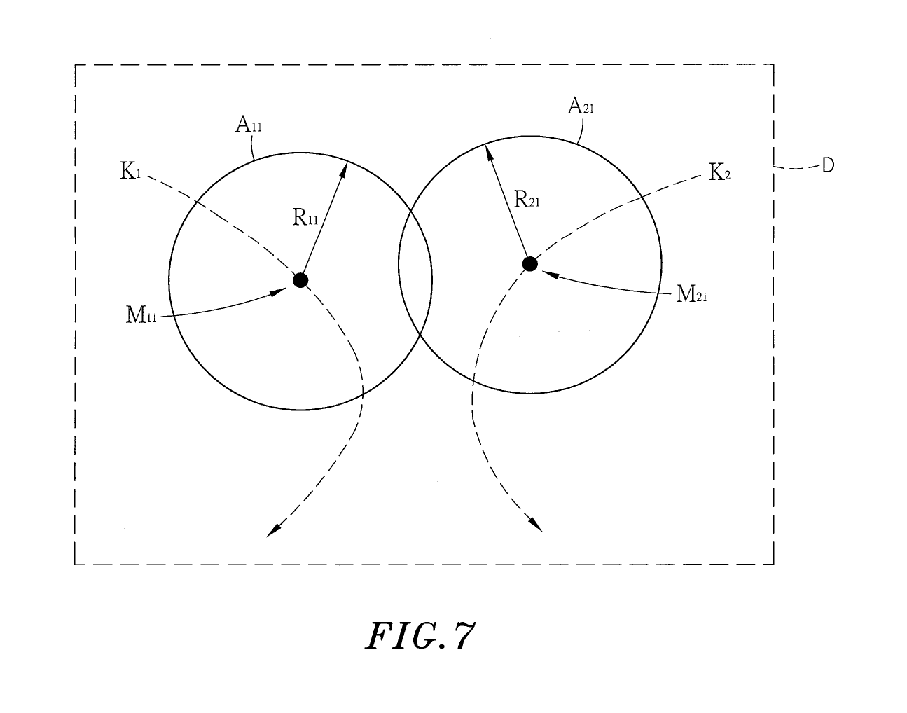

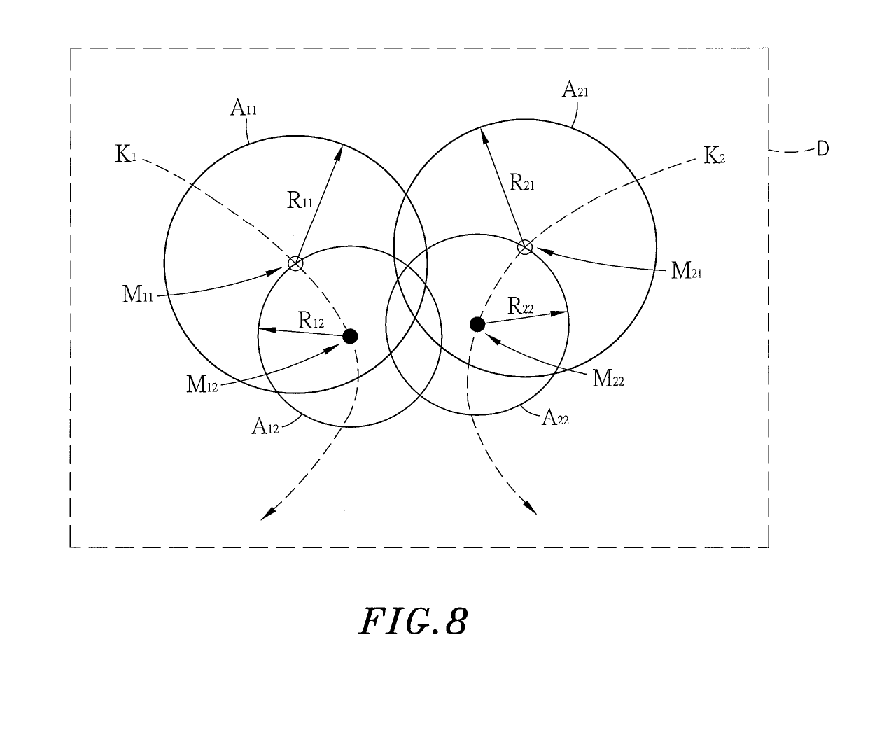

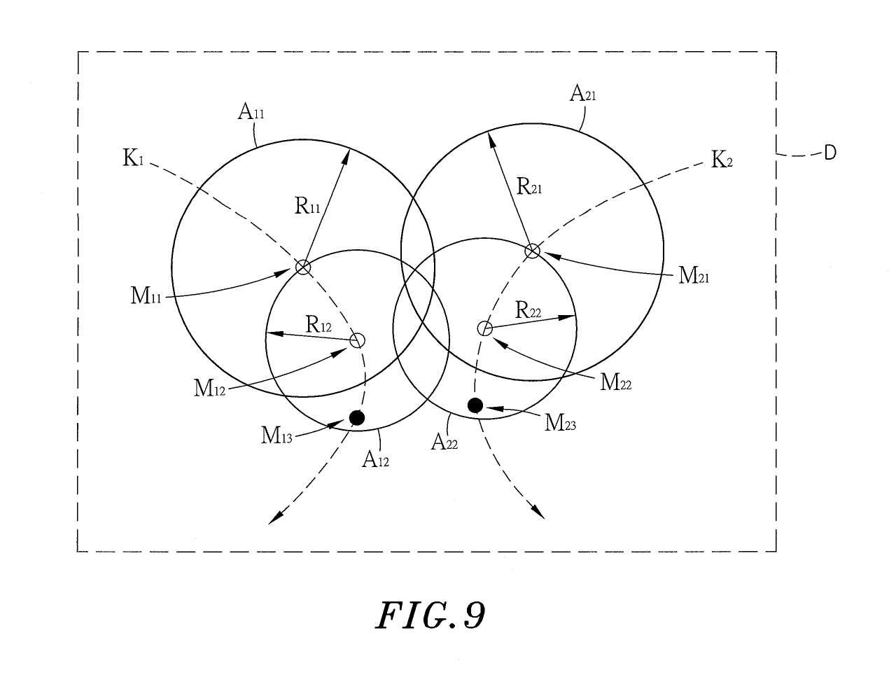

Referring to FIGS. 7-9 and FIG. 3 again, when two parallel objects simultaneously touch the touch sensing panel 11 and move on the touch sensing panel 11 inwardly in direction toward each other to create respective moving trajectories K₁,K₂, because the second sensing radiuses R₁₂,R₂₂ of the second trajectory sensing areas A₁₂,A₂₂ respectively exhibit positive correlation with the respective movement speeds V₁₂,V₂₂, the second trajectory sensing areas A₁₂,A₂₂ around the respective second touch points M₂,M₂₂ are relatively reduced subject reduction of the respective movement speeds V₁₂,V₂₂ at the respective turning points, thereby shortening the respective second sensing radiuses R₁₂,R₂₂, and therefore, the two adjacent second touch points M₁₂,M₂₂ fall into the respective second trajectory sensing areas A₁₂,A₂₂, preventing the control unit 12 from determining the second touch points M₁₂,M₂₂ to be within one same moving trajectory.

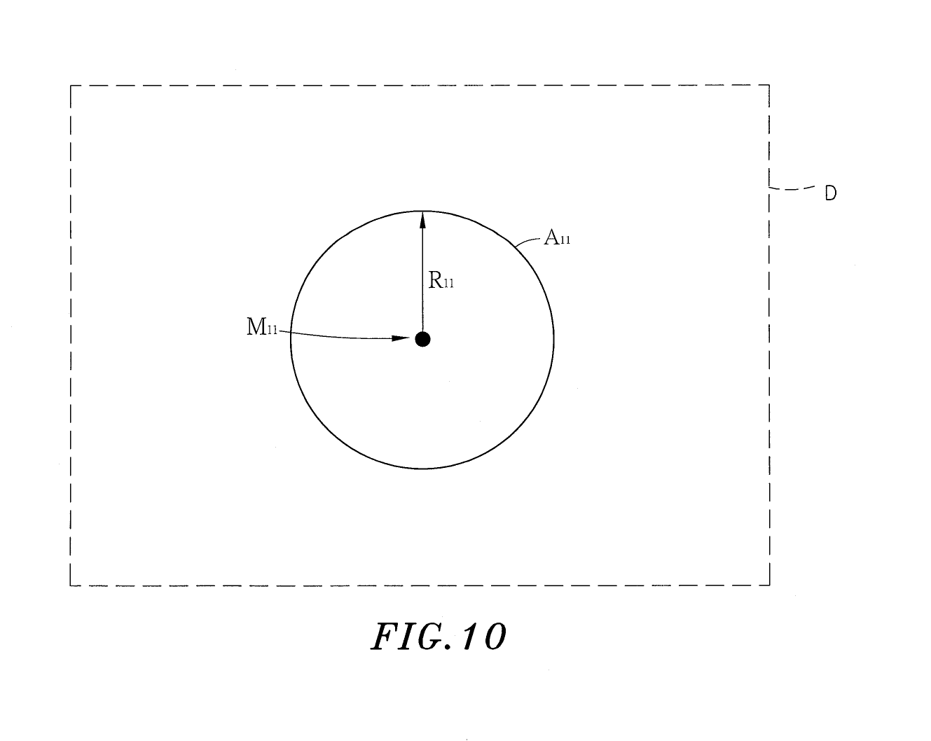

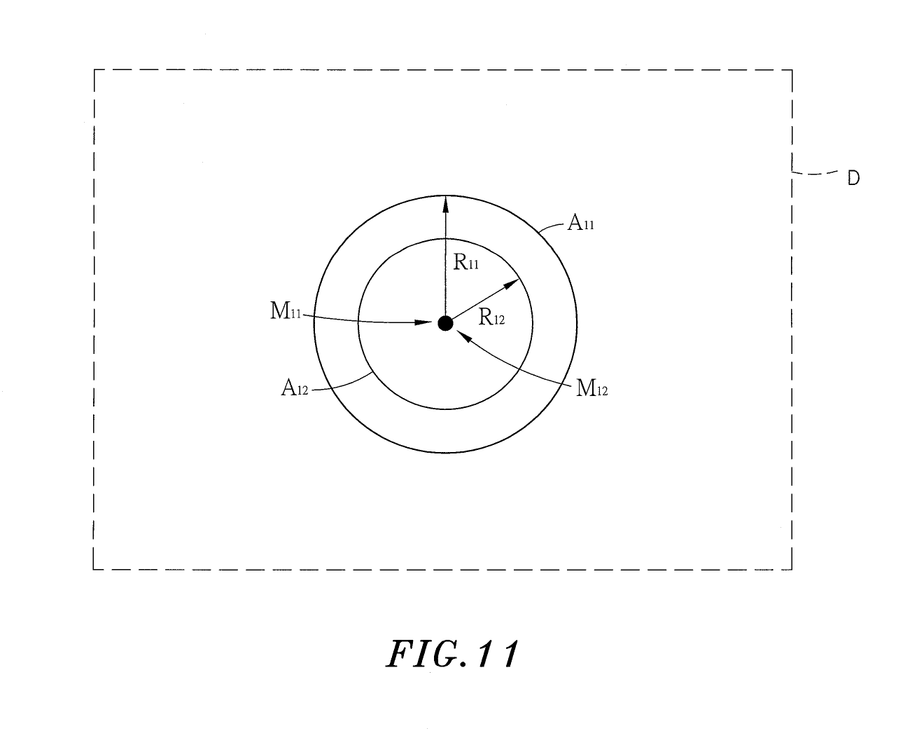

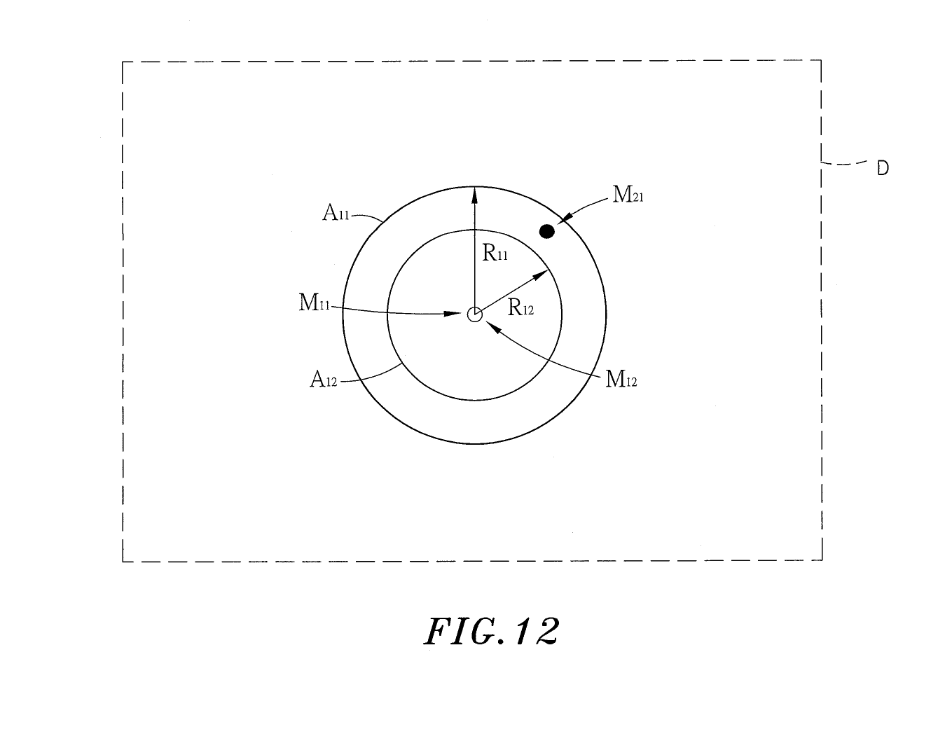

Referring to FIGS. 10-12 and FIG. 3 again, when an object simultaneously touches the touch sensing panel 11 and is then stayed at the touch point to create a moving trajectory K₁, because the second sensing radius R₁₂ of the second trajectory sensing area A₁₂ exhibits a positive correlation with the movement speed V₁₂, the movement speed V₁₂ of the second touch point M₁₂ is zero. At this time, the second trajectory sensing area A₁₂ around the second touch point M₁₂ is reduced subject to the zeroed movement speed V₁₂, and thus, the follow-up touched first touch point M₂₁ near the second touch point M₁₂ will not fall within the second trajectory sensing area A₁₂, preventing the control unit 12 from determining the second touch point M₁₂ and the first touch point M₂₁ to be within one same moving trajectory.

In the above-described first, second and third application examples, two objects are moved into contact with two adjacent locations at the touch sensing panel 11, and then stayed immovable or simultaneously moved along the surface of the touch sensing panel 11. However, these application examples are not intended to limit the scope of the present invention. In actual application of the touch trajectory sensing method, the method can determine the moving trajectory of one, two, three, four or even five objects at the touch sensing panel 11, where the movement speed of the touch point of each object exhibits a positive correlation with the respective trajectory sensing area.

It is to be noted that the implementation that the touch trajectory sensing method determines the second trajectory sensing area A₁₂ of the second touch point M₁₂ according to the movement speed V₁₂ of the second touch point M₁₂ is simply an example but not intended for use to limit the scope of the present invention. When multiple objects are moved on the touch sensing panel 11 to generate multiple moving trajectories (such as moving trajectories K₁,K₂), the control unit 12 will acquire multiple touch points (such as first touch points M₁₁,M₂₁, second touch points M₁₂,M₂₂, third touch points M₁₃,M₂₃, etc.) from the respective moving trajectories in a proper order, and then define the respective trajectory sensing areas (such as second trajectory sensing areas A₁₂,A₂₂) around the acquired touch points according to the respective movement speeds (such as movement speeds V₁₂,V₂₂, etc.). Because the respective sensing radius (such as second sensing radius R₁₂,R₂₂, etc.) of the respective trajectory sensing areas exhibit a positive correlation with the movement speeds of the respective touch points, when multiple objects, when multiple objects are operated to perform special sliding operations such as stayed at respective touch points on the touch sensing panel 11 or change of direction, each touch point has a relatively smaller trajectory sensing area at the turning point or retarded point on the touch sensing panel 11, preventing adjacent touch points at different moving trajectories from falling to the respective opponent second trajectory sensing areas to further eliminate the control unit 12 from making a wrong moving trajectory determination on the adjacent touch points and causing the touch sensing panel 11 to perform an unexpected touch control operation, and thus, the invention can provide the user with excellent touch operation experience.

In conclusion, the invention provides a touchscreen device and a touch trajectory sensing method used in the touchscreen device and adapted for determining the moving trajectory of each object being moved into contact with the touch sensing panel 11 of the touchscreen device 1 and the trajectory sensing area around each touch point according to the movement speed of the respective touch point, where the trajectory sensing area exhibits a positive correlation with the movement speed so that when multiple objects are simultaneously moved into contact with the touch sensing panel 11 and then stayed at the respective touch points, or steered on the touch sensing panel 11, each touch point has a relatively smaller trajectory sensing area at the turning point or retarded point on the touch sensing panel 11, preventing adjacent touch points at different moving trajectories from falling to the respective opponent second trajectory sensing areas to further eliminate the control unit 12 from making a wrong moving trajectory determination on the adjacent touch points.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A touchscreen device, comprising:
a touch sensing panel comprising a plurality of driving lines, a plurality of sensing lines respectively intersected with said driving lines, and a sensing point located at each intersection between each said driving line and each said sensing line for enabling a control unit to detect a first touch point and second touch point when an external object touches one said sensing point and stayed at the touched point or moved on said touch sensing panel; and
a control unit electrically connected with said driving lines and said sensing lines of said touch sensing panel;
wherein said control unit is adapted for acquiring a first touch point from one said sensing point of said touch sensing panel and defining a first trajectory sensing area around said first touch point and then acquiring a second touch point from one said sensing point of said touch sensing panel upon contact of an external object with said touch sensing panel, and determining that said first touch point and said second touch point are of different moving trajectories if said second touch point falls outside said first trajectory sensing area, or determining that said first touch point and said second touch point are of one same moving trajectory if said second touch point falls within said first trajectory sensing area, and then computing the movement speed of said second touch point and then defining a second trajectory sensing area around said second touch point according to the computed movement speed of said second touch point; said second trajectory sensing area exhibits a positive correlation with the movement speed of said second touch point.

2. The touchscreen device as claimed in claim 1, wherein said control unit defines said first trajectory sensing area by drawing a perfect circle around said first touch point using a first sensing radius.

3. The touchscreen device as claimed in claim 2, wherein if said first touch point is the initial touch point of the moving trajectory of said first touch point, the length of said first sensing radius is a predetermined initial value; if said first touch point is not the initial touch point of the moving trajectory of said first touch point, said first touch point has a movement speed, and said control unit defines said first sensing radius according to the movement speed of said first touch point where the length of said first sensing radius exhibits a positive correlation with the movement speed of said first touch point.

4. The touchscreen device as claimed in claim 1, wherein said control unit defines said second trajectory sensing area around said second touch point by drawing a perfect circle around said second touch point using a second sensing radius, where the length of said second sensing radius exhibits a positive correlation with the movement speed of said second touch point.

5. The touchscreen device as claimed in claim 4, wherein said second sensing radius of said second trajectory sensing area is smaller than a predetermined upper limit value.

6. The touchscreen device as claimed in claim 1, wherein the multiple said sensing points located at the intersections between said driving line and said sensing line constitute a Cartesian coordinate system; said first touch point and said second touch point each get the respective coordinates in said Cartesian coordinate system.

7. The touchscreen device as claimed in claim 6, wherein said first touch point and said second touch point have the same coordinates.

8. A touch trajectory sensing method used in a touchscreen device comprising a touch sensing panel, said touch sensing panel comprising a plurality of driving lines, a plurality of sensing lines respectively intersected with said driving lines and a sensing point located at each intersection between each said driving line and each said sensing line, and a control unit electrically coupled with said driving lines and said sensing lines of said touch sensing panel, the touch trajectory sensing method comprising the steps of:
enabling said control unit to acquire a first touch point from one said sensing point of said touch sensing panel and then to define a first trajectory sensing area around said first touch point and then to acquire a second touch point from one said sensing point of said touch sensing panel upon contact of an external object with said touch sensing panel;
enabling said control unit to determine that said first touch point and said second touch point are of different moving trajectories if said second touch point falls outside said first trajectory sensing area;
enabling said control unit to determine that said first touch point and said second touch point are of one same moving trajectory if said second touch point falls within said first trajectory sensing area, and then enabling said control unit to compute the movement speed of said second touch point and then to define a second trajectory sensing area around said second touch point according to the computed movement speed of said second touch point, wherein said second trajectory sensing area exhibits a positive correlation with the movement speed of said second touch point.

9. The touchscreen device as claimed in claim 8, wherein said control unit defines said first trajectory sensing area by drawing a perfect circle around said first touch point using a first sensing radius.

10. The touchscreen device as claimed in claim 9, wherein if said first touch point is the initial touch point of the moving trajectory of said first touch point, the length of said first sensing radius is a predetermined initial value; if said first touch point is not the initial touch point of the moving trajectory of said first touch point, said first touch point has a movement speed, and said control unit defines said first sensing radius according to the movement speed of said first touch point where the length of said first sensing radius exhibits a positive correlation with the movement speed of said first touch point.

11. The touchscreen device as claimed in claim 8, wherein said control unit defines said second trajectory sensing area around said second touch point by drawing a perfect circle around said second touch point using a second sensing radius, where the length of said second sensing radius exhibits a positive correlation with the movement speed of said second touch point.

12. The touchscreen device as claimed in claim 11, wherein said second sensing radius of said second trajectory sensing area is smaller than a predetermined upper limit value.

13. The touchscreen device as claimed in claim 8, wherein the multiple said sensing points located at the intersections between said driving line and said sensing line constitute a Cartesian coordinate system; said first touch point and said second touch point each get the respective coordinates in said Cartesian coordinate system.

14. The touchscreen device as claimed in claim 13, wherein said first touch point and said second touch point have the same coordinates in one embodiment; said first touch point and said second touch point have different coordinates in another embodiment.
